(19) United States
(12) Patent Application Publication
(10) Pub. No.: US 2010/0003479 A1
(43) Pub. Date: Jan. 7, 2010

(54) LAMINATED CERAMIC SUBSTRATE

(75) Inventors: Young Nam Hwang, Suwon (KR); Young Bok Yoon, Yongin (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHNICS CO., LTD.

(21) Appl. No.: 12/370,241

(22) Filed: Feb. 12, 2009

(30) Foreign Application Priority Data
Jul. 4, 2008 (KR) 10-2008-0065108

(51) Int. Cl. B32B 7/00

(52) U.S. Cl. 428/213

(57) ABSTRACT

Provided is a laminated ceramic substrate. The laminated ceramic substrate includes a first ceramic layer, a second ceramic layer, and a third ceramic layer. The first ceramic layer is formed of a material with a first thermal expansion coefficient. The second ceramic layer is laminated on one side of the first ceramic layer. The second ceramic layer is formed of a material with a second thermal expansion coefficient different from the first thermal expansion coefficient. The third ceramic layer is laminated on the other side of the first ceramic layer. The third ceramic layer is formed of a material with the second thermal expansion coefficient. The third ceramic layer has a different thickness than the second ceramic layer.

### CROSS-REFERENCE TO RELATED APPLICATIONS

This application claims the priority of Korean Patent Application No. 2008-0065108 filed on Jul. 4, 2008, in the Korean Intellectual Property Office, the disclosure of which is incorporated herein by reference.

### BACKGROUND OF THE INVENTION

1. Field of the Invention

The present invention relates to a laminated ceramic substrate, and more particularly, to a laminated ceramic substrate that can prevent a crack from occurring at the surface due to a shrinkage that occurs in a firing process.

2. Description of the Related Art

High-frequency electronic components are known in the art. Examples of the high-frequency electronic components are high-frequency switches, Voltage-Controlled oscillators (VCOs), and amplifiers that are configured in such a way that semiconductor devices, such as Field-Effect Transistors (FETs) and diodes, or electronic devices, such as resistance devices, capacitance devices, and inductance devices are mounted on the surface of a substrate formed of, for example, plastic or ceramic. Such a substrate requires a thermal protection, an improvement in electrical characteristics, and the protection of semiconductor devices or electronic devices against mechanical stresses.

Recently, in the technical field of mobile communications such as portable phones, a demand for the miniaturization of constituent circuit components is strong, and a laminated ceramic substrate in which capacitance devices and inductance devices are installed in a ceramic body by Low Temperature Co-fired Ceramics (LTCC) technology is used.

A method of fabricating such a laminated ceramic substrate includes: forming a laminated body by laminating a plurality of ceramic green sheets having conductive patterns and via holes formed on a surface thereof; and firing the laminated body. Because the firing process of the laminated body is performed at high temperatures or at low temperatures, the ceramic green sheets shrink during the firing process. The firing temperature of a ceramic material used to form the laminated body is about 800° C. to about 950° C., and a metal such as argentum (Ag) widely used to form an internal electrode may exhibit a shrinkage behavior at a temperatures of about 400° C. to about 550° C.

Particularly, in the case of a laminated ceramic substrate formed by laminating different types of ceramic sheets, a crack may occur in the surface of the laminated ceramic substrate after the firing process because the different types of ceramic sheets are different in terms of thermal expansion coefficients. Such a crack may cause a moisture infiltration, thus leading to a problem in the performance or reliability of the laminated ceramic substrate.

### SUMMARY OF THE INVENTION

An aspect of the present invention provides a structure of a laminated ceramic substrate that can prevent a crack from occurring at a surface thereof.

According to an aspect of the present invention, there is provided a laminated ceramic substrate including: a first ceramic layer; a second ceramic layer laminated on one side of the first ceramic layer; and a third ceramic layer laminated on the other side of the first ceramic layer and having a different thickness than the second ceramic layer.

A neutral plane, which has a normal stress of 0 that is generated at a sectional surface when a bending moment is applied thereto, may be formed in the second ceramic layer.

The second ceramic layer may be thicker than the third ceramic layer. In this case, the first ceramic layer may be thinner than the second ceramic layer and may be thicker than the third ceramic layer.

The first ceramic layer may be formed of a material with a first thermal expansion coefficient, and the second ceramic layer may be formed of a material with a second thermal expansion coefficient different from the first thermal expansion coefficient.

The third ceramic layer and the second ceramic layer may be formed of the same material.

The first thermal expansion coefficient may be greater than the second thermal expansion coefficient. In this case, the first ceramic layer may contain a high-permittivity material that has a relative permittivity of about 15 to about 50, and the second ceramic layer may contain a low-permittivity material that has a relative permittivity of about 10 or less.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a laminated ceramic substrate according to an exemplary embodiment of the present invention;

FIG. 2A is a cross-sectional view of a laminated ceramic substrate according to an exemplary embodiment of the present invention; and

FIG. 2B is a cross-sectional view of a laminated ceramic substrate according to a comparative example to be compared with the exemplary embodiment of the present invention.

### DETAILED DESCRIPTION OF THE PREFERRED EMBODIMENT

Exemplary embodiments of the present invention will now be described in detail with reference to the accompanying drawings.

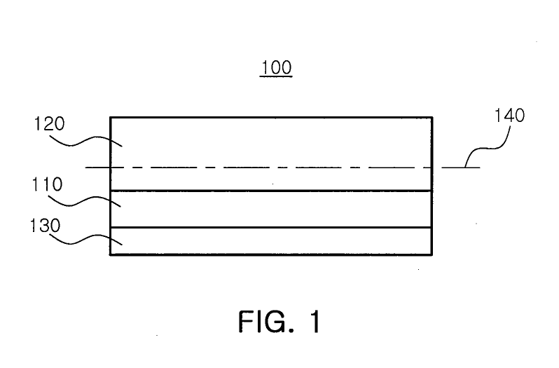

FIG. 1 is a cross-sectional view of a laminated ceramic substrate according to an exemplary embodiment of the present invention.

Referring to FIG. 1, a laminated ceramic substrate according to the exemplary embodiment of the present invention may include a first ceramic sheet 110, a second ceramic sheet 120, and a third ceramic sheet 130.

The first ceramic sheet 110 may be formed of a material with a first thermal expansion coefficient. The first ceramic sheet 110 may contain a high-permittivity material with a high relative permittivity. In the present embodiment, the first ceramic sheet 110 may be formed using a material with a relative permittivity of about 15 to about 50. The constituent material of the first ceramic sheet 110 may be a Ba—Ti—Nd based ceramic material mixed with an about 8 wt % to about 23 wt % Zn—Si based glass material.

The second ceramic sheet 120 may be laminated on the top of the first ceramic sheet 110. The second ceramic sheet 120 may be formed of a material with a second thermal expansion coefficient. The second thermal expansion coefficient may be lower than the first thermal expansion coefficient. The second ceramic sheet 120 may contain a low-permittivity material with a low relative permittivity. In the present embodiment, the second ceramic sheet 120 may be formed using a material with a relative permittivity of about 10 or less. The constituent material of the second ceramic sheet 120 may include alumina (Al₂O₃) and Zn—Si based glass.

The third ceramic sheet 130 may be laminated under the bottom of the first ceramic sheet 110. The third ceramic sheet 130 may be formed of a material having the same thermal expansion coefficient as the material of the second ceramic sheet 120. The thickness of the third ceramic sheet 130 may be smaller than the thickness of the second ceramic sheet 120.

The external shape of the laminated ceramic substrate 100 maybe deformed due to a stress applied to each of the ceramic sheets. When the laminated ceramic substrate 100 is deformed, a bending moment is applied to each of the ceramic sheets. If a load is applied to a laminated body, a force is applied to bend the laminated body, which is called a bending moment. When a bending moment is applied to a laminated body and thus a bending deformation is generated, a tensile force is applied to a convex layer and a compressive force is applied to a concave layer. A plane between them, to which neither the tensile force nor the compressive force is applied, that is, a plane with a normal stress of 0 is called a neutral plane.

A neutral plane 140, which is an imaginary plane with a bending moment of 0, is present in the laminated ceramic substrate 100. If all of the ceramic sheets constituting the laminated ceramic substrate 100 are formed of the same material, the neutral plane 140 maybe formed at the center of the thickness of the laminated body. However, in the case of the laminated ceramic substrate 100 formed by laminating ceramic sheets with different permittivities according to the present embodiment, the location of the neutral plane 140 may be determined by the thicknesses and Young's moduli of the laminated ceramic sheets. The Young's modulus means the modulus of elasticity that is determined by the material of the ceramic sheet. In the present embodiment, the second ceramic sheet 120 and the third ceramic sheet 130 are different in thickness and are laminated with the first ceramic sheet 110 interposed therebetween, so that the neutral plane 140 can be located to deviate in one direction from the center of the laminated ceramic sheet. In the present embodiment, because the second ceramic sheet 120 is thicker than the third ceramic sheet 130, the neutral plane 140 can be located at the second ceramic sheet 120.

When the laminated ceramic substrate 100 is fired, a shrinkage may occur in each of the first ceramic sheet 110, the second ceramic sheet 120 and the third ceramic sheet 130 that are laminated in the laminated ceramic substrate 100. Because the adjacent ceramic sheets are different in thermal expansion coefficient, the degree of shrinkage can be different in each of the ceramic sheets. In the present embodiment, the second ceramic sheet 120 is formed to be thicker than the third ceramic sheet 130, so that the bending moment 140 of the laminated ceramic substrate 100 is located at the second ceramic sheet 120 and thus the top and the bottom of the laminated ceramic substrate 100 can be different in terms of the degree of shrinkage during the firing process. Accordingly, it is possible to relatively reduce a stress that is generated between the first ceramic sheet 110 and the second or third ceramic sheet 120 or 130 during the firing process. Thus, it is possible to reduce a crack that may be generated in the surface of the laminated ceramic substrate 100 during the firing process.

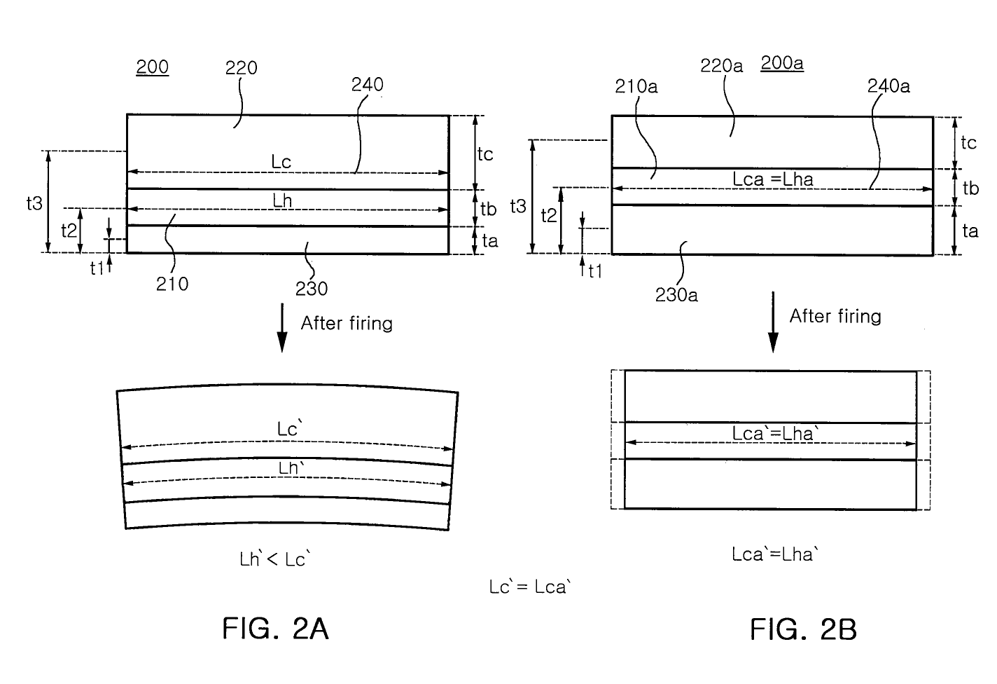

FIG. 2A is a cross-sectional view of a laminated ceramic substrate according to an exemplary embodiment of the present invention, and FIG. 2B is a cross-sectional view of a laminated ceramic substrate according to a comparative example to be compared with the exemplary embodiment of the present invention.

Referring to FIG. 2A, a laminated ceramic substrate 200 according to the exemplary embodiment of the present invention may include a first ceramic sheet 210, a second ceramic sheet 220, and a third ceramic substrate 230 that are laminated therein. Herein, the first ceramic sheet 210 may contain a high-permittivity material, and the second ceramic sheet 220 and the third ceramic sheet 230 may contain a low-permittivity material. The second ceramic sheet 220 and the third ceramic sheet 230 may have the same permittivity, and the second ceramic sheet 220 may be formed to be thicker than the third ceramic sheet 230.

Referring to FIG. 2B, a laminated ceramic substrate 200a according to the comparative example may include a first ceramic sheet 210a, a second ceramic sheet 220a, and a third ceramic substrate 230a that are laminated therein. Herein, the second ceramic sheet 220a and the third ceramic sheet 230a maybe formed to have the same thickness. The first ceramic sheet 210a may contain a high-permittivity material, and the second ceramic sheet 220a and the third ceramic sheet 230a may contain a low-permittivity material. The second ceramic sheet 220a and the third ceramic sheet 230a may have the same permittivity.

A comparison will now be made between the locations of neutral planes formed in the laminated ceramic substrates illustrated in FIGS. 2A and 2B.

The locations of the neutral planes formed in the laminated ceramic substrates may be determined using Equation (1) below.

$${t}_{bc} = \frac{{t}_{1} {E}_{1} + {t}_{2} {E}_{2} + {t}_{3} {E}_{3}}{{E}_{1} + {E}_{2} + {E}_{3}} \qquad ( 1 )$$

In Equation (1), E₁, E₂ and E₃ respectively denote the Young's moduli of the third ceramic sheet 230/230a, the first ceramic sheet 210/210a and the second ceramic sheet 220/220a; t₁, t₂ and t₃ respectively denote the distances between the bottom surface and the centers of the third ceramic sheet 230/230a, the first ceramic sheet 210/210a and the second ceramic sheet 220/220a; and tₐ, t_{b} and t_{c} respectively denote the thicknesses of the third ceramic sheet 230/230a, the first ceramic sheet 210/210a and the second ceramic sheet 220/220a.

In the case of the laminated ceramic substrate 200a illustrated in FIG. 2B, because the third ceramic sheet 330a and the second ceramic sheet 320a are formed of materials with the same permittivity and have the same thickness, E₁ is equal to E₃ and tₐ is equal to t_{c}.

Thus, the distance tbc between the bottom surface and a neutral plane 240a, which is calculated by Equation (1), is equal to the distance t₂ between the bottom surface and the center of the first ceramic sheet 210a.

In the case of the laminated ceramic substrate 200 illustrated in FIG. 2A, because the third ceramic sheet 330 and the second ceramic sheet 320 are formed of materials with the same permittivity but have different thicknesses, E₁ is equal to E₃ but tₐ is not equal to t_{c}.

Thus, the distance tbc between the bottom surface and a neutral plane 240, which is calculated by Equation (1), is greater than the distance t₂ between the bottom surface and the center of the first ceramic sheet 210. That is, the neutral plane 240 is formed at the second ceramic sheet 220.

A description will now be made of the degree of deformation of the laminated ceramic substrate 200/200a after the firing process.

In the case of the laminated ceramic substrate 200a illustrated in FIG. 2B, because the second ceramic sheet 220a and the third ceramic sheet 230a have the same permittivity, they have the same thermal expansion coefficient. Also, because the second ceramic sheet 220a and the third ceramic sheet 230a have the same thickness, the laminated ceramic substrate 200a shrinks only along the laminated surface during the firing process without bending in the vertical direction. In this case, after the firing process, the length Lca′ of the neutral plane is equal to the length Lha′ of the central line of the first ceramic sheet 210a.

In the case of the laminated ceramic substrate 200 illustrated in FIG. 2A, because the second ceramic sheet 220 and the third ceramic sheet 230 have the same permittivity, they have the same thermal expansion coefficient. However, because the second ceramic sheet 220 and the third ceramic sheet 230 have different thicknesses, the laminated ceramic substrate 200 bends in the vertical direction during the firing process due to a difference in shrinkage force. In this case, after the firing process, the length Lc′ of the neutral plane is not equal to the length Lh′ of the central line of the first ceramic sheet 210. Herein, after the firing process, the length Lc′ of the neutral plane is greater than the length Lh′ of the central line of the first ceramic sheet 210. Although the shapes of the laminated ceramic substrates 200 and 200a of FIGS. 2A and 2B are different in terms of the neutral planes, if the respective ceramic sheets are formed of the same material and are fired by the same firing process, the degrees of shrinkage in the respective shapes are identical to each other. That is, after the firing process, the length Lc′ of the neutral plane in the laminated ceramic substrate 200 of FIG. 2A is equal to the length Lca′ of the neutral plane in the laminated ceramic substrate 200a of FIG. 2B.

Thus, it can be seen that the degree of shrinkage of the first ceramic sheet 210 in the laminated ceramic substrate 200 of FIG. 2A is smaller than the degree of shrinkage of the first ceramic sheet 210a in the laminated ceramic substrate 200a of FIG. 2B. Thus, in comparison with the comparative example illustrated in FIG. 2B, the exemplary embodiment of the present invention illustrated in FIG. 2A can reduce the stress generated in the first ceramic sheet during the firing process.

From the simulation results, a comparison will now be made between the degrees of stresses in the laminated ceramic substrates 200 and 200a of FIGS. 2A and 2B during the firing process.

The first ceramic sheet 210/210a contains a high-permittivity material and has a Young's modulus of about 110 GPa; and the second ceramic sheet 220/220a and the third ceramic sheet 230/230a contain a low-permittivity material and have a Young's modulus of about 67 GPa. The first ceramic sheet 210/210a has a thermal expansion coefficient of about 13.0×10⁻⁶; and the second ceramic sheet 220/220a and the third ceramic sheet 230/230a have a thermal expansion coefficient of about 5.0×10⁻⁶.

In the case of the laminated ceramic substrate 200 illustrated in FIG. 2A, the first ceramic sheet 210 was formed to a thickness of about 0.1 mm; the second ceramic sheet 220 was formed to a thickness of about 0.45 mm; and the third ceramic sheet 230 was formed to a thickness of about 0.05 mm.

In the case of the laminated ceramic substrate 200a illustrated in FIG. 2B, the first ceramic sheet 210a was formed to a thickness of about 0.1 mm; the second ceramic sheet 220a was formed to a thickness of about 0.25 mm; and the third ceramic sheet 230a was formed to a thickness of about 0.25 mm.

As a result of the simulation using the above samples, a stress applied to the first ceramic sheet 210 during the firing process of the laminated ceramic substrate 200 illustrated in FIG. 2A was about 270 MPa; and a stress applied to the first ceramic sheet 210a during the firing process of the laminated ceramic substrate 200a illustrated in FIG. 2B was about 327 MPa. Thus, it can be seen that a stress generated between different types of laminated ceramic sheets in the laminated ceramic substrate 200 of FIG. 2A is smaller than a stress generated between different types of laminated ceramic sheets in the laminated ceramic substrate 200a of FIG. 2B. Thus, it can be seen that the laminated ceramic substrate according to the exemplary embodiment of the present invention can reduce the generation of a crack during the firing process.

As described above, the present invention can provide a laminated ceramic substrate with improved performance and reliability by preventing a crack from occurring at a surface thereof.

While the present invention has been shown and described in connection with the exemplary embodiments, it will be apparent to those skilled in the art that modifications and variations can be made without departing from the spirit and scope of the invention as defined by the appended claims.

What is claimed is:

1. A laminated ceramic substrate comprising:
a first ceramic layer;
a second ceramic layer laminated on one side of the first ceramic layer; and
a third ceramic layer laminated on the other side of the first ceramic layer and having a different thickness than the second ceramic layer.

2. The laminated ceramic substrate of claim 1, wherein a neutral plane, which has a normal stress of 0 that is generated at a sectional surface when a bending moment is applied thereto, is formed in the second ceramic layer.

3. The laminated ceramic substrate of claim 1, wherein the second ceramic layer is thicker than the third ceramic layer.

4. The laminated ceramic substrate of claim 3, wherein the first ceramic layer is thinner than the second ceramic layer and is thicker than the third ceramic layer.

5. The laminated ceramic substrate of claim 1, wherein the first ceramic layer is formed of a material with a first thermal expansion coefficient, and the second ceramic layer is formed of a material with a second thermal expansion coefficient different from the first thermal expansion coefficient.

6. The laminated ceramic substrate of claim 5, wherein the third ceramic layer and the second ceramic layer are formed of the same material.

7. The laminated ceramic substrate of claim 5, wherein the first thermal expansion coefficient is greater than the second thermal expansion coefficient.

8. The laminated ceramic substrate of claim 7, wherein the first ceramic layer contains a high-permittivity material that has a relative permittivity of about 15 to about 50.

9. The laminated ceramic substrate of claim 7, wherein the second ceramic layer contains a low-permittivity material that has a relative permittivity of about 10 or less.
